(19) United States
(12) Patent Application Publication
(10) Pub. No.: US 2008/0259796 A1
(43) Pub. Date: Oct. 23, 2008

(54) METHOD AND APPARATUS FOR NETWORK-ADAPTIVE VIDEO CODING

(76) Inventors: Glen Patrick Abousleman, Scottsdale, AZ (US); Wei-Jung Chien, Tempe, AZ (US); Lina Karam, Scottsdale, AZ (US)

Correspondence Address: FULBRIGHT & JAWORSKI L.L.P., 600 CONGRESS AVE., SUITE 2400, AUSTIN, TX, 78701, US

(21) Appl. No.: 12/105,130

(22) Filed: Apr. 17, 2008

Related U.S. Application Data
(60) Provisional application No. 60/912,539, filed on Apr. 18, 2007.

(51) Int. Cl. H04L 12/24

(52) U.S. Cl. 370/233

(57) ABSTRACT

Methods and devices for a media processing is provided. In one respect, the methods can provide initiating a bandwidth throttle or a frame rate throttle when resources of a network exceed resources of client device. The methods of the present disclosure may also provide techniques for handling lost packets during transmission using wavelet coefficients.

### CROSS-REFERENCE TO RELATED APPLICATIONS

This application claims priority to, and incorporates by reference, U.S. Provisional Patent Application Ser. No. 60/912,539 entitled, “METHOD AND APPARATUS FOR NETWORK-ADAPTIVE VIDEO CODING,” which was filed on Apr. 17, 2007.

### BACKGROUND OF THE INVENTION

1. Field of the Invention

This invention relates to image/video processing, and more particularly, to a coder/decoder for processing images/video for transmission over low-bandwidth channels.

2. Description of Related Art

The advent of media streaming has allowed users to have a readily available stream of media at or near real-time. However, current technologies, while providing some advances in media streaming, are unable to adjust to the demands of the network while providing real-time capabilities. Accordingly, a significant need exists for the techniques described and claimed in this disclosure, which involves various improvements to the current techniques of the art.

### SUMMARY OF THE INVENTION

The present disclosure provides a substantially real-time video coder/decoder (codec) for use with low-bandwidth channels where the bandwidth is unknown or varies with time. The codec may incorporate a modified JPEG2000 core and interframe or intraframe predictive coding, and may operate with network bandwidths of less than 1 kbits/second. The encoder and decoder may establish two virtual connections over a single IP-based communications link. The first connection may be a UDP/IP guaranteed throughput, which may be used to transmit a compressed video stream in real time, while the second connection may be a TCP/IP guaranteed delivery, which may be used for two-way control and compression parameter updating. The TCP/IP link may serve as a virtual feedback channel and may enable a decoder to instruct an encoder to throttle back the transmission bit rate in response to the measured packet loss ratio. The codec may also enable either side to initiate on-the-fly parameter updates such as bit rate, frame rate, frame size, and correlation parameter, among others. The codec may also incorporate frame-rate throttling whereby the number of frames decoded may be adjusted based upon the available processing resources. Thus, the proposed codec may be capable of automatically adjusting the transmission bit rate and decoding frame rate to adapt to any network scenario. Video coding results for a variety of network bandwidths and configurations may be presented to illustrate the vast capabilities of the proposed video coding system.

In one respect, a method is provided. The method may determine a server transmit rate and a maximum bit rate of a network. If the server transmit rate exceeds the maximum bit rate of the network, a bandwidth throttle may be initiated.

In other respects, a method may determine a transmission rate of a network and a computational load of at least one client device. If the computational load of at least one client device is less than the transmission rate of the network, a frame rate throttle may be initiated.

The methods of the present disclosure may be performed with a program storage device readable by a machine (e.g., a computer, a laptop, a PDA, or other processing unit) executing instructions to perform the steps of the methods. In addition or alternatively, a hardware device (e.g., field programmable array, ASIC, chips, control units, and other physical devices) may be used to perform the steps of the methods.

The term “coupled” is defined as connected, although not necessarily directly, and not necessarily mechanically.

The terms “a” and “an” are defined as one or more unless this disclosure explicitly requires otherwise.

The term “substantially,” “about,” “approximation” and its variations are defined as being largely but not necessarily wholly what is specified as understood by one of ordinary skill in the art, and in one non-limiting embodiment these terms refer to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWING

The following drawings form part of the present specification and are included to further demonstrate certain aspects of the present disclosure. The figures are examples only. They do not limit the scope of the disclosure.

FIG. 1 is a system overview, in accordance with embodiments of the present disclosure.

FIG. 2 is a flowchart of a method processed by a server, in accordance with embodiments of the present disclosure.

FIG. 3 is a flowchart of a method processed by a client device, in accordance with embodiments of the present disclosure.

FIG. 4 is a block diagram of JPEG2000, in accordance with embodiments of the present disclosure.

FIG. 5 is a graph showing bandwidth throttling, in accordance with embodiments of the present disclosure.

FIG. 6 is a diagram of splitting coefficients over a plurality of channels, in accordance with embodiments of the present disclosure.

FIGS. 7(a) through 7(d) show neighboring coefficients, in accordance with embodiments of the present disclosure.

FIGS. 8(a) through 8(c) show varying frames of a person, in accordance with embodiments of the present disclosure.

FIGS. 8(d) through 8(f) show varying frames of a water scene, in accordance with embodiments of the present disclosure.

FIGS. 8(g) through 8(i) show varying frames of a hallway, in accordance with embodiments of the present disclosure.

FIGS. 9(a) through 9(h) illustrate channel-loss resilience, in accordance with embodiments of the present disclosure.

### DETAILED DESCRIPTION OF THE INVENTION

The disclosure and its various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those of ordinary skill in the art from this disclosure.

The present disclosure provides a wavelet-based video coding system that is optimized for transmission over ultra-low bandwidth, IP-based communication links. The efficient, software-based implementation enables real-time video encoding/decoding on multiple platforms, including, for example, a Windows, Unix, or Linux-based platform. The system may allow on-the-fly adjustment of coding parameters such as, but not limited to, bit rate, frame rate, temporal correlation, and single/multiple channel operation, which enables it to adapt to a wide variety of IP-based network configurations. For multichannel or noisy-channel operation, the video data may be split in such a manner that lost wavelet coefficients can be interpolated from neighboring coefficients, thus improving the performance in the case of packet/channel loss. Simulation results show that the developed video coder provides outstanding performance at low bit rates, and that the post-processing scheme gives considerable improvement in the case of packet/channel loss.

Transmission of digital video data over IP-based links may facilitate communications among users throughout the world. The applications benefiting from real-time video transmission may include military, medical, humanitarian, and distance learning, among others. These applications not only require diverse quality requirements for video, but they also face dynamic network bandwidth limitations. Unfortunately, the existing video compression standards such as the MPEG variants or ITU-T H.26x are often not suitable for these applications. For example, the transmission bandwidth provided by a single Iridium® satellite communication channel is only 2.4 kilobits per second (kbps), which is outside the range of conventional video compression standards.

In this disclosure, an automatic, network-adaptive, ultra-low-bit-rate video coding system is provided. The proposed system may be software-based and may operate on any platform such as a Windows/Linux/Unix platform. The method may accommodate a wide variety of applications with a selectable transmission bit rate of 0.5 kbps to 20 Mbps, a selectable frame rate of 0.1 to 30 frames per second (fps), a selectable group of pictures (GOP) size, and selectable intraframe/interframe coding modes. The method may also incorporate a sophisticated bandwidth throttling mechanism that allows for automatically finding a maximum sustainable bandwidth available on a particular link. Additionally, if the processing capability of the platform is insufficient to maintain the chosen frame rate, the system may automatically adjust the frame rate to accommodate the limited processing capability.

### Network-Adaptive Video Coding

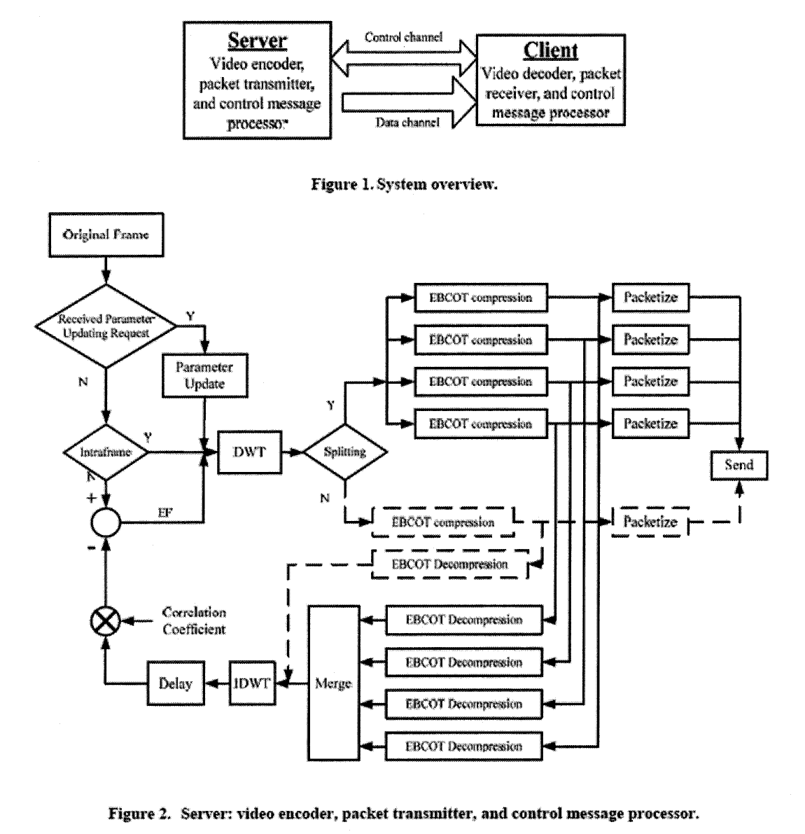

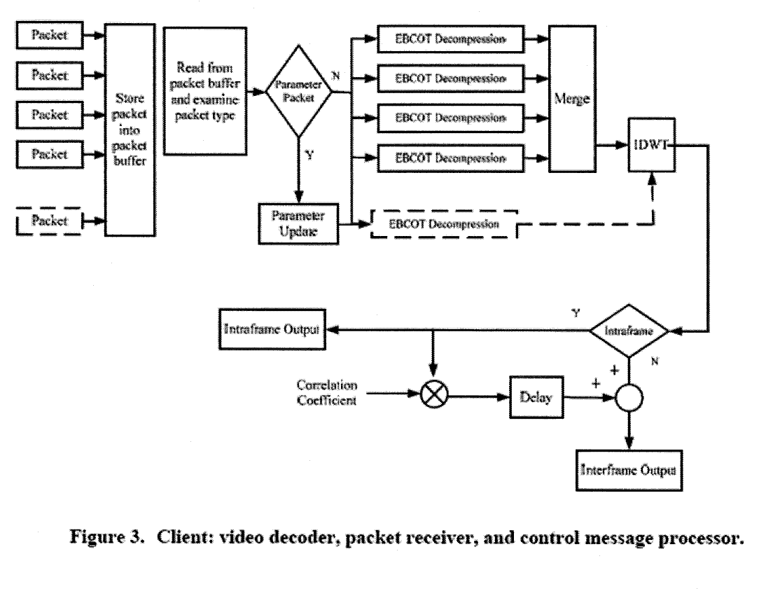

The proposed video coding system may be designed as a server-client system, and may be capable of point-to-point transmission or one-to-many broadcast. A block diagram of the system is shown in FIG. 1. The server and client may communicate via two disparate network channels. The first is called the data channel and may be responsible for video packet data transmission. The second is called the control channel and may be used for video parameter transmission and control message exchange. Because the video parameters and control messages are critical pieces of information, the control channel may be implemented with a guaranteed-delivery TCP/IP connection. The packet error mechanism that is embedded within the TCP/IP specification may guarantee the correctness of the control information. On the other hand, for substantially or true realtime video transmission, the video data packets may be time-critical information and must be transmitted without undue delay. Thus, the data channel may be implemented with a UDP/IP connection.

FIG. 2 illustrates the block diagram of the server. The server may include three components: a video encoder, a video packet transmitter, and a control message processor. The video encoder design may be based upon a modified JPEG2000 image compression core and DPCM (“Differential Pulse Coded Modulation”) predictive coding, and may operate in either splitting or nonsplitting modes. In the splitting mode, the video encoder may equally divide one video frame into four small frames and compresses them. The server may subsequently transmit these packets through the data channel, which may be a physically independent or virtually independent network link. The video packet transmitter may packetize the compressed video codewords and transmit them through the predefined network link. Finally, the control message processor may interpret the control message transmitted from the client and may determine when to transmit the current video parameter settings.

The procedural flow of the server can be described as follows. First, the original frame may be acquired or “grabbed” from either a video file or a camera. The control processor checks if there is a request for updating the video parameters. If a parameter update event occurs, the frame may be encoded using intraframe coding. Otherwise, the frame may be encoded using either intraframe or interframe coding, depending upon its location within the GOP. A DPCM prediction loop may be implemented for interframe coding, which generates error frames. The discrete wavelet transform (DWT) may then be applied on either the original frame or the error frame, and the wavelet coefficients may be compressed into video codewords using EBCOT compression. The packet transmitter may packetize the codewords into video packets by adding the frame number, packet type, and packet number, and then transmits them over the network.

The client may also include three components. First, the packet receiver may be responsible for receiving video packets from the predefined channel, extracting the video codewords from the video packets, and placing them in a video buffer. A control message processor may be included for extracting the video parameters if a parameter packet is received, and may generate control messages if the decoder is in an unstable state, such as insufficient bandwidth or insufficient processing capability. The client may also include a video decoder for decoding received video codewords.

The decoder may include two independent threads that may operate simultaneously. These threads may be the video packet receiver and video decoder. The video packet receiver may store the received video packets into the packet buffer. When the packet buffer contains enough packets for displaying, the video decoder may read and process the video packets. If a video packet is accompanied by a parameter packet, the video packet receiver may update the video decoder with the received parameters contained in the parameter packet, and the video decoder may decode the video frame.

Details regarding the video coding algorithm, control channel, parameter updating, and other system components are presented in the following sections.

### Video Coding Algorithm

The proposed video coding system may be based on the JPEG2000 standard. JPEG2000 is a wavelet-based image coding method that may use Embedded Block Coding with Optimum Truncation (EBCOT) algorithm. It was developed to provide features that are not present in the original JPEG standard such as lossy and lossless compression in one system, different progression orders (SNR, resolution, spatial location, and component), and better compression at low bit rates.

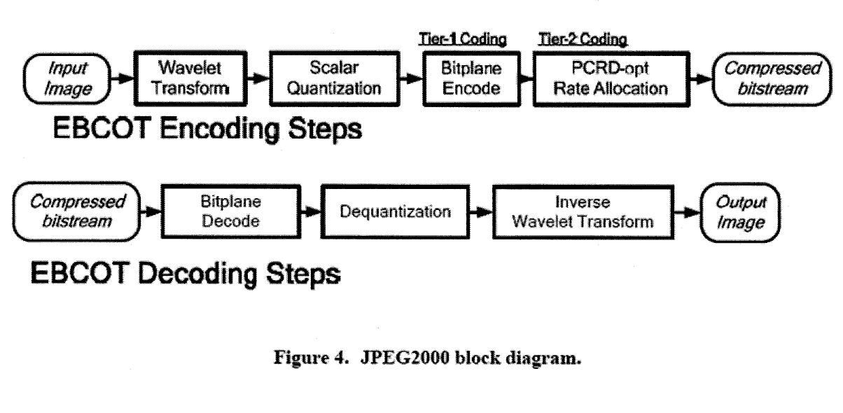

The basic block diagram of the JPEG2000 compression/decompression algorithm is shown in FIG. 4. The EBCOT algorithm may include two stages: Tier1 and Tier2 coding. The Tier1 coding stage includes bitplane coding, while the Tier2 coding stage includes Post Compression Rate Distortion optimization (PCRDopt) algorithm for optimum allocation of the final bit stream. If the original image samples are unsigned values, they may be shifted in level such that they form a symmetric distribution of the discrete wavelet transform (DWT) coefficients for the LL sub-band. The DWT may be applied to the signed image samples. If lossy compression is chosen, the transformed coefficients may be quantized using a dead-zone scalar quantizer. The bitplanes may be coded from the most significant bitplane (MSB) to the least significant bitplane (LSB) in the Tier1 coding stage, which has three coding passes—the significance propagation pass, the magnitude refinement pass, and the cleanup pass. The significance propagation pass may code the significance of each sample based upon the significance of the neighboring eight pixels. The sign coding primitive may be applied to code the sign information when a sample is coded for the first time as a nonzero bitplane coefficient. The magnitude refinement pass may code only those pixels that have already become significant. The cleanup pass may code the remaining coefficients that are not coded during the first two passes. The output symbols from each pass may be entropy coded using context-based arithmetic coding. After all bitplanes are coded, the PCRD-opt algorithm may be applied in the Tier2 coding stage to determine the contribution of each coding block to the final bit stream.

### TCIP/IP Control Channel and Parameter Updates

The proposed system may be designed to operate over a vast range of compression settings. The following is a set of parameters. One of ordinary skill in the art can recognize that other setting parameters may be used.

I. Video sizes: {640×480, 352×288, 320×240, 176×144, and 160×120}

II. Bit-rates: {0.5 kbps to 20 Mbps}

III. Frame rates: {0.1 fps to 30 fps}

IV. GOP size: {1 (intraframe coding only) to 30}

V. Receiver buffer size: {0 to 6 seconds}

VI. Intraframe/interframe compression rate ratio: {1 to 8}

VII. DPCM correlation coefficient: {0.1 to 1.0}

These parameters may be necessary for video decoding at the client. Therefore, they may be synchronized with the video encoder at the server. One possible approach to maintain synchronization may be to embed these parameters into each video packet header in order to overcome potential loss due to erroneous transmission. However, this parameter embedding process may create redundancy that may be significant for ultra-low-bit-rate applications. To preserve these parameters during transmission without introducing redundancy, the video parameter packet may be transmitted using TCP/IP. Because the parameter packet contains only several bytes and is transmitted only when the server changes its settings, it may occupy an insignificant percentage of transmission bandwidth. The procedural flow for parameter updating is as follows. First, the user may change the current settings from the GUI. The video encoder may then modify the memory structure based upon the new settings and may transition to the initial state whereby a new GOP is to be coded. At the same time, the packet transmitter may immediately packetize the settings and transmits the parameter packet over the control channel. After sending the parameter packet, the server may compress the next video frame with the updated settings and transmits the compressed frame over the data channel. Before the client decompresses this frame, it may update the video decoder in accordance with the received parameter packet so that the frame can be decoded correctly. The above procedure may assume that the parameter packet has arrived at the receiver before the video date packet; otherwise, the client will pause the decoding to avoid decoding error.

### Bandwidth Throttling

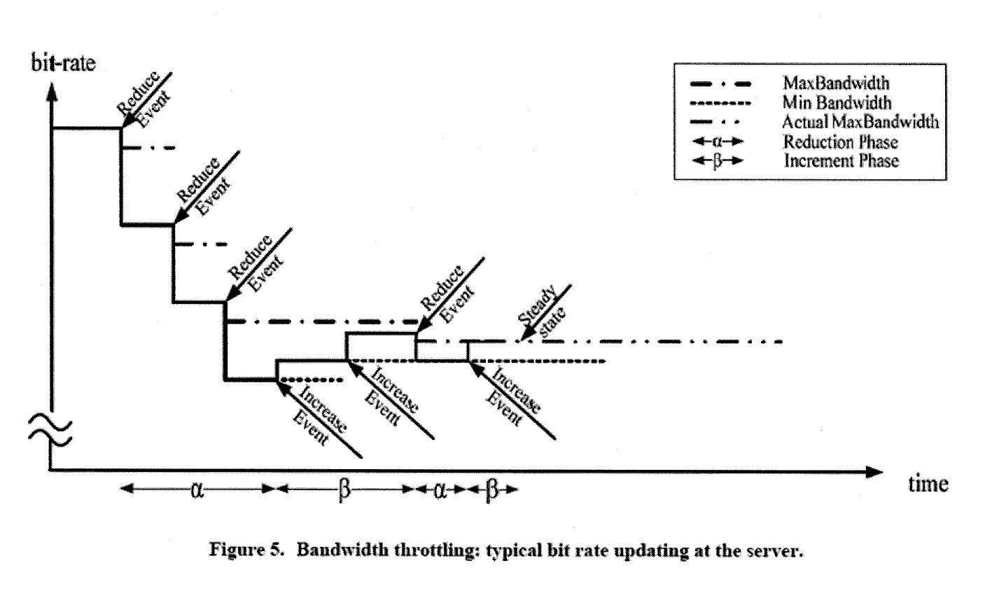

Generally speaking, it may be difficult to determine the effective bandwidth of a network, especially wireless networks. The bandwidth of wireless networks may be affected by position, weather, terrain, radio power, distance, etc. The maximum stated bandwidth of a network may not equate to the maximum transmission bit rate of the video transmission system. For example, an ISDN link between two 56 kbps modems can usually support video transmission at only 30 kbps. (Experimentation over a variety of links supports this conclusion). Thus, to determine the maximum bit rate that a network can support, a bandwidth throttling mechanism that automatically finds the maximum sustainable bandwidth available on a particular link is presented. If the server transmits compressed video at a rate that exceeds the maximum bit rate of the network, the client may exhibit two abnormal behaviors: the actual frame rate is lower than the specified frame rate, and the receive buffer enters an underflow condition. Bandwidth throttling may be performed when these two conditions are present. The concept is shown in FIG. 5, and consists of reduction and increment phases.

Referring to FIG. 5, once bandwidth throttling is activated, the reduction phase (“reduce”) may be performed first. The client may initially send a bandwidth reduction message through the control channel to the server. The server may adjust the bit rate to 80% of the current bit rate setting or to the minimum bandwidth, and it decreases the maximum bit rate to 95% of the current bit rate, although the percentage may vary. The video transmission may be paused until the client sends another control message, which is called a resume message. Because the network may still be congested with video packets that were sent before the bit rate was changed, the client may not send the resume message until no additional packets are being received; otherwise, the new transmitted video packets may be blocked or delayed because of the congested network link. After the server receives the resume message, the new parameter settings may be sent immediately along with the new video packets. The process may repeat several times until the video compression bit rate is lower than the actual maximum bandwidth of the network.

The second phase is the increment phase, and is designed to approach the actual maximum bandwidth from below. When a bandwidth reduction message is processed, the server may reduce its bit rate to 80% of the current bit rate. In practice, however, the actual maximum bandwidth may fall within the reduction gap. The increment phase may incrementally adjust the bit rate until another reduction phase is activated or until the maximum bit rate is achieved. This is shown as an increase event in FIG. 5. When the maximum bit rate is achieved, the system may enter a steady state condition, which indicates the actual maximum bandwidth or steady-state bandwidth as shown in FIG. 5. When the system is in steady state, the reduction and increment phases may still be activated due to fluctuations in the network bandwidth. Note, however, that once in steady state, the maximum bandwidth may not change during the reduction phase, and the increment phase will always try to return to the steady-state bandwidth.

### Frame Rate Throttling

For some applications, the client may have insufficient computational resources to decode the received video packets. For example, suppose that a helicopter is transmitting surveillance video at 10 fps to a ground soldier who needs the video to execute his mission. Assume that the network bandwidth is large enough to support the video transmission, but that the soldier only has a handheld device that can perform video decoding at 5 fps. Obviously, the handheld device, e.g., client, will accumulate 5 frames every second in the buffer, and the time lag between the server and the client will become increasingly longer. After several minutes, the video may become outdated, as it cannot provide effective situational awareness for the quickly varying battlefield. Accordingly, a frame rate throttling mechanism to guarantee frame synchronization between server and client is presented. Such a mechanism can enable the transmission of tactically useful video over ultra-low-bandwidth communication links.

Assume that the majority of the video client's computational load is due to the video decoding. That is, the packet receiver takes only a small portion of the computational resources because it may listen on the network and copies received packets to the video buffer. If the client has insufficient computational resources, the number of frames copied into the receive buffer may be larger than the number of frames that are decoded and displayed. This results in the receive buffer always being full, and the actual decoded frame rate being much less than the server frame rate. The occurrence of both conditions may result in the triggering of the frame rate throttling mechanism.

To initiate frame rate throttling, the client may send a message to the server requesting that the encoding frame rate be decreased. Upon receipt of the message, the server may reduce its encoding frame rate to 67% of the original frame rate. The server may then send a parameter update packet to the client and continue to transmit video packets. Once the client receives the parameter packet, it may flush the receive buffer and begin to store the video packets with the updated frame rate. The procedure may repeat until the client's processor can accommodate the server's frame rate.

The previous scenario focuses on point-to-point transmission. In some embodiments, the system of the present disclosure may also supports multicast communications, allowing multiple users to view the same real-time video stream. A different throttling strategy is used in this situation. Here, assume that the multiple clients on the network have equal importance, and that a client is not allowed to change the encoding frame rate. In this case, each client can initiate “local” frame rate throttling by skipping frames within each GOP. For example, suppose that the server is encoding video at 20 fps, and that clients A and B run at 15 fps and 20 fps, respectively, and that the GOP is set to 10 frames. Client B is capable of decoding the full 20 fps, so it does not activate its frame rate throttling mechanism. However, client A can only decode 15 fps. Once its receive buffer is full and the actual decoding frame rate is calculated as 15 fps, its local frame rate throttling will be activated, and it will simply skip the last 5 frames in each GOP. Although some of the frames will not be decoded, the time lag between the server and the client will not increase, thus preserving the real-time characteristic of the server-client system, which is critical in surveillance and control applications.

### Splitting of Wavelet Coefficients for Error Resilience

An error-resilience scheme called “splitting” is adopted to maximize the video quality if video packets are lost during transmission. In the splitting scheme, the wavelet coefficients are split in such a manner as to facilitate the estimation of lost coefficients. This post-processing scheme can remove visually annoying artifacts caused by lost packets and can increase the obtained peak signal-to-noise ration (PSNR). The scheme relies on the knowledge of the loss pattern. That is, the wavelet coefficients of a video frame are divided into four groups, where each group is coded separately, packetized, and assigned a packet number prior to transmission over four virtual (or physical) channels. In this way, the decoder is aware of which channels have undergone packet loss, and which neighboring coefficients are available for reconstruction.

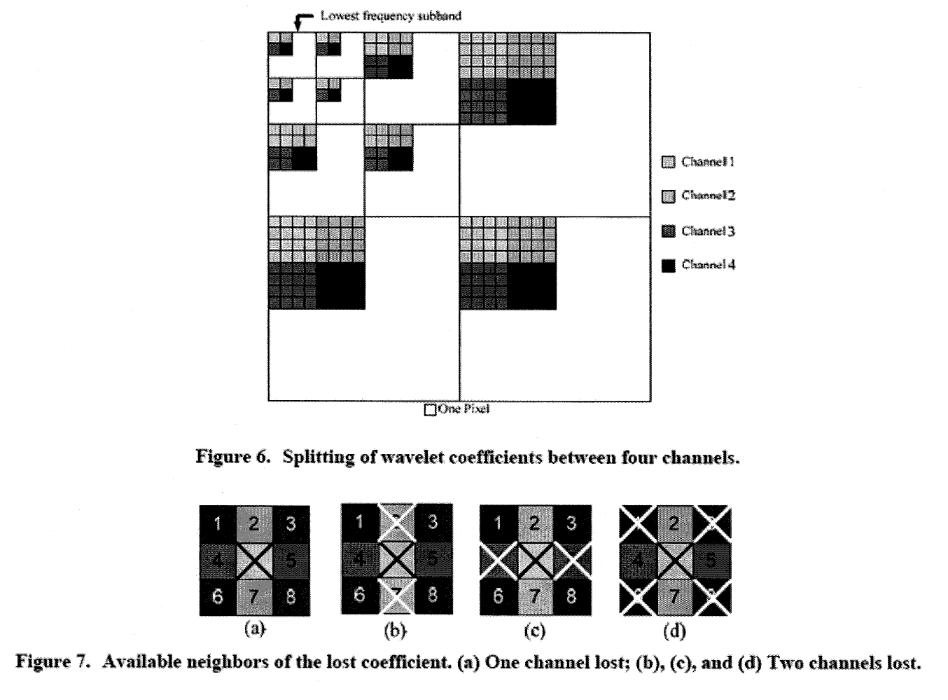

If a channel or packet is lost, this corresponds to the loss of one coefficient in the lowest-frequency subband, and to lost groups of coefficients in other subbands, as shown in FIG. 6. The lowest-frequency subband may include most of the energy in the image, so reconstruction of this subband may have the greatest impact on the overall image quality. If only one channel is lost (the most common case encountered, as shown in FIG. 7(a)), each lost wavelet coefficient may have eight connected neighbors that may be used to form an estimate. (It has been shown that median filtering gives the best results in terms of PSNR and visual quality.) Thus, each lost coefficient in the lowest-frequency subband may be replaced by

Xₗₒₛₜ=median(X₁ . . . X₈), Eq. 1,

where X₁ . . . X₈ are the eight available neighbors. If the coefficient is at the boundary of the image, the number of neighbors may change according to the topology. If two channels are lost, each lost coefficient may have three different sets of available neighbors, as shown in FIG. 7(b-d). Thus, the lost coefficient in the lowest-frequency subband may be replaced by the median value of the available neighbors. If more than two packets are lost, the client may remove the received packets from the buffer and skip the frame.

### Results

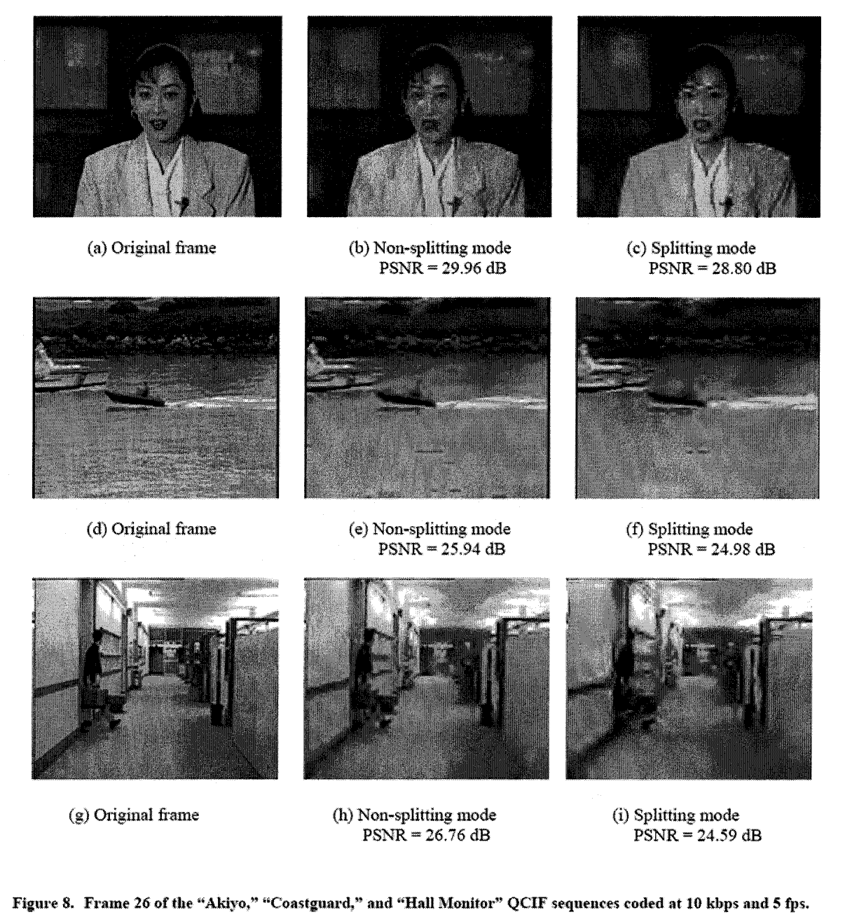

The proposed video compression system was tested for several standard Quarter Common Intermediate Format (QCIF) (176 by 144 pixels) video sequences including a person (FIGS. 8A-8C), a water scene (FIGS. 8D-8F), and a hallway (FIGS. 8G-8J). The video was compressed at 5 frames per second using an overall bit rate of 10 kbps and 30 kbps. The results using both non-splitting and splitting modes are shown in Table 1.

TABLE 1
Average PSNR at Different Bit Rates

| | | Person Scene | Water Scene | Hallway Scene |
|---|---|---|---|---|
| 10 kps | Non-Splitting | 31.19 dB | 24.69 dB | 26.46 dB |
| | Splitting | 28.82 dB | 23.55 dB | 24.29 dB |
| 30 kps | Non-Splitting | 37.72 dB | 28.01 dB | 33.22 dB |
| | Splitting | 36.12 dB | 27.03 dB | 31.05 dB |

FIGS. 8 (b), (e), and (h) show Frame 26 of the QCIF person, water scene, and hallway video sequences coded at 10 kbps, respectively, each at 5 fps, using the proposed video coding scheme in non-splitting mode, while FIGS. 8 (c), (f), and (i) show the same sequences coded in splitting mode. The frame shown was coded as an intraframe in all cases, and the resulting PSNR values are also given. For comparison, the original QCIF frames are shown in FIGS. 8 (a), (d), and (g). In all cases, note the outstanding video quality obtained despite of the extremely low encoding rate of 10 kbps.

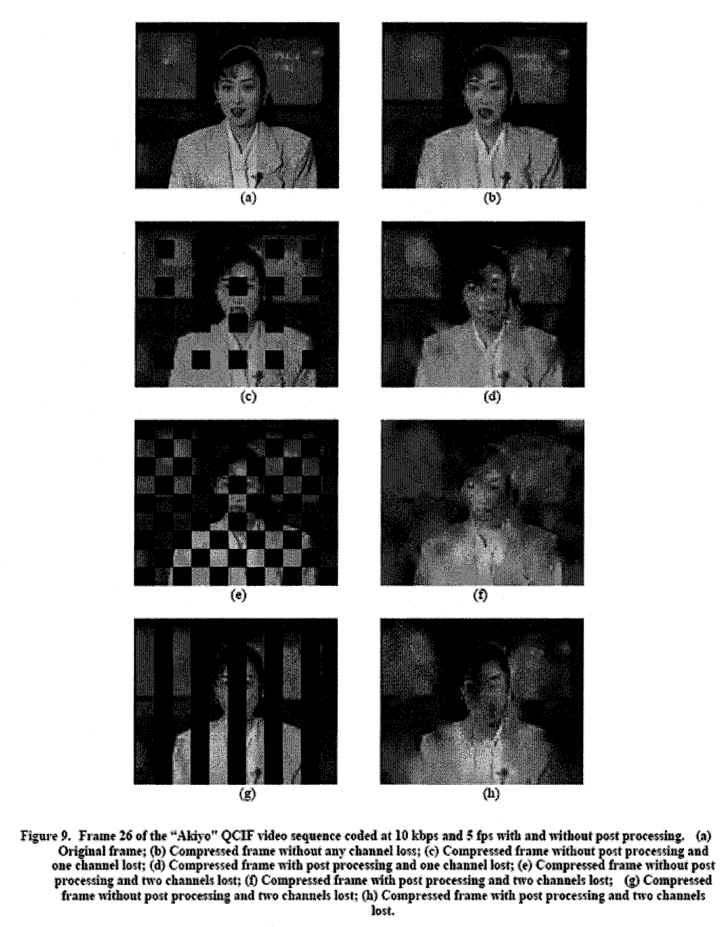

To illustrate the channel-loss resilience of the proposed codec, FIG. 9 shows Frame 26 of the person video sequence coded at 10 kbps and 5 fps when one and two channels are lost. FIG. 9 (c) shows the sequence with one channel lost and no post processing, while FIG. 9 (d) shows one channel lost with post processing. Similarly, FIGS. 9 (e) and (g) show different outcomes of two channels lost with no post processing, while FIGS. 9 (f) and (h) are the results with post processing. For comparison, FIG. 9 (a) shows the original frame and FIG. 9 (b) shows the compressed frame with no channel loss. As seen from the figures, the post-processing scheme provides substantial improvements in the quality of the video in the presence of packet/channel loss.

The present disclosure provides a wavelet-based video coding system optimized for transmission over ultra-low bandwidth, IP-based communication links. The efficient, implementation enables real-time video encoding/decoding on any Windows/Unix/Linux-based platform. The system allows on-the-fly adjustment of coding parameters such as bit rate, frame rate, temporal correlation, and single/multiple channel operation, which enables it to adapt to a wide variety of IP-based network configurations. For multichannel or noisy-channel operation, the video data is split in such a manner that lost wavelet coefficients can be interpolated from neighboring coefficients, thus improving the performance in the case of packet/channel loss. Simulation results show that the developed video coder provides outstanding performance at low bit rates, and that the post-processing scheme gives considerable improvement in the case of packet/channel loss.

Techniques of this disclosure may be accomplished using any of a number of programming languages. For example, techniques of the disclosure may be performed on a computer readable medium. Suitable languages include, but are not limited to, BASIC, FORTRAN, PASCAL, C, C++, C#, JAVA, HTML, XML, PERL, SQL, SAS, COBOL, etc. An application configured to carry out the invention may be a stand-alone application, network based, or wired or wireless Internet based to allow easy, remote access. The application may be run on a personal computer, a data input system, a point of sale device, a PDA, cell phone or any computing mechanism.

Computer code for implementing all or parts of this disclosure may be housed on any processor capable of reading such code as known in the art. For example, it may be housed on a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc. The computer code may be executable on any processor, e.g., any computing device capable of executing instructions according to the methods of the present disclosure. In one embodiment, the processor is a personal computer (e.g., a desktop or laptop computer operated by a user). In another embodiment, processor may be a personal digital assistant (PDA), a cellular phone, a gaming console, or other handheld computing device.

In some embodiments, the processor may be a networked device and may constitute a terminal device running software from a remote server, wired or wirelessly. Input from a source or other system components may be gathered through one or more known techniques such as a keyboard and/or mouse, and particularly may be received form image device, including but not limited to a camera and/or video camera. Output may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The processor may use any type of monitor or screen known in the art, for displaying information. For example, a cathode ray tube (CRT) or liquid crystal display (LCD) can be used. One or more display panels may also constitute a display. In other embodiments, a traditional display may not be required, and the processor may operate through appropriate voice and/or key commands.

With the benefit of the present disclosure, those having skill in the art will comprehend that techniques claimed herein may be modified and applied to a number of additional, different applications, achieving the same or a similar result. The claims cover all such modifications that fall within the scope and spirit of this disclosure.

### REFERENCES

Each of the following references is hereby incorporated by reference in its entirety:
ISO/IEC 15444-1, JPEG2000 image coding system—Part 1: core coding system, ISO, Tech. Rep., 2000.
D. Taubman, High Performance Scalable Image Compression with EBCOT, IEEE Transactions on Image Processing, 9(7):1151-1170, 2000.
S. Channappayya et al., In: Coding of Digital Imagery for Transmission over Multiple Noisy Channels, in Proceedings of the IEEE Intl. Conf. on Acoustics, Speech and Signal Processing, Vol. 3, 2001.
K. S. Tyldesley et al., Error-resilient multiple description video coding for wireless transmission over multiple iridium channels, in Proceedings of the SPIE, Vol. 5108, 2003.

1. A method of compressing, transmitting or decompressing media, the method comprising:
determining a server transmit rate;
determining a maximum bit rate of a network; and
initiating a bandwidth throttle if the server transmit rate exceeds the maximum bit rate of the network.

2. The method of claim 1, where initiating a bandwidth throttle comprises a reduction phase where the server adjusts the transmit rate to an amount less than the network maximum bit rate.

3. The method of claim 2, further comprising initiating an increment phase for incrementally increasing the transmit rate.

4. The method of claim 1, further comprising providing real-time adjustment of a coding parameter selected from the group consisting of bit rate, frame rate, temporal correlation, single-channel operation and multi-channel operation.

5. A method of compressing, transmitting or decompressing media, the method comprising:
determining a transmission rate of a network;
determining a computational load of a client device; and
initiating a frame rate throttle if the computational load of the client device is less than the transmission rate of the network.

6. The method of claim 5, where determining a computational load comprises determining video decoding time of the client device.

7. The method of claim 5, where determining a computational load comprises determining if a receive buffer of the client device is full.

8. The method of claim 5, where determining a computational load further comprises determining if a server frame rate is greater than a decoded frame rate of the client device.

9. The method of claim 5, where initiating a frame rate throttle comprises sending a message from the client to a server requesting an encoding frame rate be decreased.

10. A method comprising:
determining a transmission rate of a network; and
determining a computational load for each of a plurality of client devices;
wherein if the transmission rate exceeds a computation load for a single client device of the plurality of client device, the single client device initiates a local frame throttle.

11. The method of claim 10, where initiating a local frame throttle comprises skipping frames within a group of pictures.

12. A method comprising initiating a frame rate throttle or a bandwidth throttle when resources of a network exceed resources of a client device.

13. The method of claim 12 further comprising a splitting scheme to maximize video quality when packets transmitted over the network are lost during transmission.

14. The method of claim 13, further comprising dividing wavelet coefficients of a video frame into a plurality of packets.

15. The method of claim 14, further comprising using a neighboring wavelet coefficient to determine the information of a lost packet if a packet from the plurality of packets is lost during transmission.

16. A program storage device readable by a machine, tangibly embodying a program of instructions executable by the machine to perform the method steps of claim 12.

17. The program storage device of claim 16, where the program of instructions comprises instructions to:
determine a server transmit rate;
determine a maximum bit rate of a network; and
initiate a bandwidth throttle if the server transmit rate exceeds the maximum bit rate of the network.

18. The program storage device of claim 16, where the program of instructions comprises instructions to:
determine a transmission rate of a network;
determine a computational load of a client device; and
initiate a frame rate throttle if the computational load of the client device is less than the transmission rate of the network.

19. A program storage device readable by a machine, tangibly embodying a program of instructions executable by the machine to perform the method steps of claim 13.

20. The program storage device of claim 19, where the program of instructions comprises instructions to perform the following functions when packets transmitted over the network are lost during transmission:
utilize a splitting scheme to maximize video quality;
divide wavelet coefficients of a video frame into a plurality of packets; and
use a neighboring wavelet coefficient to determine the information of a lost packet.
